(19) United States
(12) Patent Application Publication
(10) Pub. No.: US 2026/0278727 A1
(43) Pub. Date: Sep. 17, 2026

(54) METHODS AND APPARATUS FOR DATA PROCESSING

(71) Applicant: Arm Limited, Cambridge (GB)

(72) Inventors: Mina Ivanova DIMOVA, Great Shelford, Cambridgeshire (GB); Daren Croxford, Swaffham Prior, Cambridgeshire (GB); Metin Gokhan Ünal, Cambridge, Cambridgeshire (GB); Roberto Lopez Mendez, Cambridge, Cambridgeshire (GB)

(21) Appl. No.: 19/079,229

(22) Filed: Mar. 13, 2025

(51) Int. Cl. G06T 1/20; G06N 20/00; G06T 15/80

(52) U.S. Cl. CPC G06T 1/20; G06N 20/00; G06T 15/80

(57) ABSTRACT

The present disclosure relates to a data processing system comprising: at least one data processing unit; at least one execution unit; and a control unit to schedule processing workload on the execution unit, wherein the at least one execution unit is capable of communicating with the at least one data processing unit via a direct pathway that bypasses the control unit, the at least one execution unit being configured to: execute an instruction responsive to a command to process data; and submit a machine learning operation to the at least one data processing unit responsive to the instruction via the direct pathway, the at least one data processing unit being configured to: execute a machine learning model responsive to receiving the machine learning operation from the at least one execution unit; perform the machine learning operation to generate inference data; and return at least a portion of the inference data to the at least one execution unit.

### FIELD

The present technology generally relates to the field of data processing and in particularly to graphics processing operations.

### BACKGROUND

Currently, data processing systems such as graphics processing systems may use machine learning operations in post-processing stages, for example to upscale a frame rate or resolution, denoising, etc. Thus, typically, one or more data processors (e.g. graphics processors) may perform data processing and the output may be sent to one or more neural processing units for machine learning post-processing.

Under such arrangements, neural processing units are independently controlled by a control unit to perform machine learning operations separately from (execution units in) data processors performing data processing under the control of the control unit. For example, the control unit may process a command (e.g. from a host processor such as a central processing unit, CPU) for data processing by breaking up the command into one or more tasks, which may include one or more machine learning tasks. The control unit then assigns processing tasks to one or more execution units in the data processor, which processes the tasks in turn and outputs the processing results to a local memory. The control unit separately assigns the machine learning tasks to one or more neural processing units, which use the processing results in the local memory to perform machine learning operations.

However, there remains scope to improve the use of machine learning operations for supporting data processing operations such as graphics processing operations. The present technology thus relates to improvements in integrating machine learning into data processing.

### BRIEF DESCRIPTION OF THE DRAWINGS

Embodiments will now be described, with reference to the accompanying drawings, in which:

FIG. 1 shows an exemplary graphics processing pipeline;

FIG. 2 shows an exemplary alternative graphics processing pipeline;

FIG. 3 shows a high-level view of an exemplary data processor system according to an embodiment;

FIG. 4 illustrates schematically data processing by an exemplary execution unit and an exemplary data processing unit according to an embodiment;

FIGS. 5A and 5B shows a graphical representation of geometric data of two exemplary scenes;

FIG. 6 shows an exemplary method of generating transformed geometric data according to an embodiment.

### DETAILED DESCRIPTION

An aspect of the present technology provides a data processing system comprising: at least one data processing unit; at least one execution unit; and a control unit to schedule processing workload on the execution unit, wherein the at least one execution unit is capable of communicating with the at least one data processing unit via a direct pathway that bypasses the control unit, the at least one execution unit being configured to: execute an instruction responsive to a command to process data; and submit a machine learning operation to the at least one data processing unit responsive to the instruction via the direct pathway, the at least one data processing unit being configured to: execute a machine learning model responsive to receiving the machine learning operation from the at least one execution unit; perform the machine learning operation to generate inference data; and return at least a portion of the inference data to the at least one execution unit.

According to embodiments of the present technology, executing an instruction to process data causes the execution unit to submit a machine learning operation to the data processing unit via a direct pathway that bypasses the control unit, in contrast with conventional arrangements. For example, the instruction may be an instruction to perform the machine learning operation, or the execution unit may determine that a machine learning operation is appropriate based on one or more criteria such as e.g. workload, efficiency, required level of detail, etc. Since the execution unit is able to directly communicate with the data processing unit, the execution unit can directly submit the machine learning operation to the data processing unit (e.g. a neural processing unit or neural engine) via the direct pathway. Upon receiving the submission from the execution unit, the data processing unit executes a suitable machine learning model to perform the required machine learning operation to generate inference data. The data processing unit then returns the generated inference data to the execution unit which uses the inference data to process the data. Through configuring the execution unit and the data processing unit to enable the execution unit to directly submit or invoke a machine learning operation to the data processing unit, it is possible to reduce (or altogether remove) the need for a control unit independently coordinating the execution unit and the data processing unit whenever a machine learning operation needs to be performed, and the direct communication facilitates the integration of machine learning into data processing to allow more processing tasks to be performed by machine learning. Arrangements according to embodiments of the present technology are therefore able to improve load balancing in a data processing system (as some of the workload can be carried out by machine learning), and bandwidth requirement between the execution unit and the data processing unit is reduced.

In some embodiments, the at least one data processing unit may be configured to return the at least a portion of the inference data to the at least one execution unit via the direct pathway.

The present technology may be applied to both conventional data processing or graphics processing pipelines e.g. involving tessellation and geometry shaders, as well as newer task mesh shader pipelines, which provide more flexibility and easier access to the topology. In some embodiments, the data processing system may be a graphics processor and the data to be processed may be graphics data, the at least one execution unit may be configured to execute the instruction in a graphics processing pipeline, and to submit a machine learning operation to the at least one data processing unit within a stage of the graphics processing pipeline. In this sense, the machine learning operation is integrated as part of the shader carrying out the stage of the graphics pipeline, in contrast to techniques where machine learning operations are performed only as pre-or post-processing operations to the graphics processing. The execution unit can generate the input for and invoke the machine learning operation and once the machine learning operation is complete the output is then (potentially) further processed by the execution unit. Thus, the machine learning operation may be preceded and/or proceeded by execution of a stage of a graphics processing pipeline.

In some embodiments, the direct pathway comprises a message passing interface. For example, the dedicated message fabric or message passing interface may be implemented to enable direct communication between the execution unit and the data processing unit, e.g. to allow the execution unit to send a message to the data processing unit to perform a machine learning operation.

In some embodiments, the at least one execution unit may be configured to generate a message and send the message to the at least one data processing unit via the message passing interface. For example, the instruction may include one or more machine learning tasks, or one or more tasks that can be performed by machine learning, and so the instruction causes the execution unit to generate a message to the data processing unit to submit the one or more machine learning tasks to the data processing unit.

In some embodiments, the message may comprise one or more of: an indication of the machine learning model to execute, input data for the machine learning operation, an indication of a location of input data for the machine learning operation, a level of processing for generating the inference data.

There may be occasions when input data for the machine learning operation is available, e.g. data from previous processing stored in a storage element, and there may be occasions when the input data is not yet available, e.g. the input data is an intermediate product of the data processing being performed by the execution unit. Thus, in some embodiments, the at least one execution unit may be configured to generate the input data for the machine learning operation.

In some scenarios, it may be inefficient for the machine learning model to be executed on data that will not be used, and it may be desirable to use different machine learning models depending on the amount of data to be processed and/or how the data is to be processed. For example, in graphics processing, data relating to geometry that is not visible (e.g. hidden behind another object or far away) will not be used in rendering and therefore can be processed minimally. Thus, in some embodiments, the at least one execution unit may be configured to determine the machine learning model to execute based on a level of detail for processing the data.

When processing graphics data, e.g. for rendering a scene, the level of detail required for a given portion of the scene or a given portion of a geometry in the scene can vary depending on a range of factors. For example, distant objects generally require a lower level of detail as they occupy fewer pixels on the screen, and if an object or a portion of the object is occluded, the occluded object or portion of the object would require less processing. Moreover, the performance of the data processing system and/or its latency, or the capability of the display for displaying the graphics data may also dictate the level of detail that is possible. Thus, in some embodiments, the data to be processed may be graphics data corresponding to a portion of geometry in a scene, and the at least one execution unit may be configured to determine the level of detail based on a position of the portion of geometry in the scene, a distance to a virtual camera position, visibility of the portion of geometry, a direction of one or more normals of the portion of geometry, current performance of the data processing system, current latency of the data processing system, or any combination thereof.

In some embodiments, wherein the data to be processed is graphics data, the at least one execution unit being configured to execute the instruction in a task mesh pipeline comprising at least a task shader and a mesh shader, and the task shader may be configured to determine the level of detail for processing the portion of geometry and submit the machine learning operation to the data processing unit with an indication of the machine learning model to execute for generating the inference data based on the level of detail. In a task mesh pipeline, task shaders are used to preprocess geometry and to optionally dispatch one or more mesh shaders, which generate the geometry. The capability of the task shaders and/or the mesh shaders may be extended to execute inference of Neural Networks (NNs). The task shaders may define the specific NNs and the level of complexity required and dispatch one or more mesh shaders accordingly. As such, it may be advantageous to submit inference workload from task shaders.

When processing a large amount of geometry, e.g. a complex scene, using machine learning, it may be desirable to process a large portion of the geometry or all of the geometry as a whole (e.g. a large portion of the scene or the whole scene) to ensure consistency across the scene and avoid discrepancies. However, a machine learning operation that involve a large amount of geometry requires more processing and is time-consuming if a good level of detail is required. Thus, in some embodiments, the at least one execution unit may be configured to submit a first machine learning operation to the at least one data processing unit to be performed on a portion of the data to be processed at a first level of processing, and to submit a second machine learning operation to the at least one data processing unit to be executed on a plurality of portions of the data to be processed at a second level of processing lower than the first level. In doing so, one machine learning operation is executed on a larger portion of data at a coarser (lower) level of processing while another machine learning operation may be executed on a smaller portion of data (finer grain) at higher level of processing independently.

In some embodiments, the data processing system may further comprise at least one storage element associated with the at least one execution unit, and the at least one execution unit may be configured to, when a portion of the inference data received from the at least one data processing unit is not used for processing the data, store the portion of the inference data in the storage element. In doing so, information that is not currently needed, e.g. information relating to part(s) of the scene not currently visible, can be stored, e.g. in an associated storage element such as a texture map and/or a displacement map, without using it in the remaining data processing of the current dataset (e.g. the current frame). Later, the unused information may be retrieved for use in subsequent data processing, e.g. for subsequent frames (e.g. for inference or other rendering effects, lighting, shadows, reflections, etc.). It is therefore possible to ensure that unused information is not lost, especially in cases where there is a dependency between consecutive frames, and at the same time minimising or reducing the additional overhead of processing data that is not currently required, e.g. not visible in the current frame.

It is less efficient for the data processing unit to be switching from one machine learning model to another. Efficiency may be improved by the execution unit keeping track of the machine learning model(s) the data processing unit is executing, and scheduling work that requires a given machine learning model when that machine learning model is already loaded into the data processing unit. Thus, in some embodiments, the at least one execution unit may be configured to, when submitting a plurality of machine learning operations to the at least one data processing unit, preferentially schedule together machine learning operations that invoke a same machine learning model.

In some embodiments, the at least one data processing unit may be a neural engine and the at least one execution unit and may be implemented as a separate unit from the at least one data processing unit, or the at least one data processing unit may be integrated into the at least one execution unit.

Another aspect of the present technology provides a method of operating a data processing system that comprises at least one data processing unit, at least one execution unit, and a control unit to schedule processing workload on the execution unit, the at least one execution unit being capable of communicating with the at least one data processing unit via a direct pathway that bypasses the control unit, the method comprising: the at least one execution unit: executing an instruction responsive to a command to process data; submitting a machine learning operation to the data processing unit responsive to the instruction via the direct pathway, the at least one data processing unit: executing a machine learning model responsive to receiving the machine learning operation from the at least one execution unit; performing the machine learning operation to generate inference data; and returning at least a portion of the inference data to the at least one execution unit.

In some embodiments, the direct pathway may comprise a message passing interface, and the method may further comprise the at least one execution unit generating a message and sending the message to the at least one data processing unit via the message passing interface.

In some embodiments, the data processing system may be a graphics processor and the data to be processed may be graphics data, and the at least one execution unit may execute the instruction in a graphics processing pipeline, the method may further comprise the at least one execution unit submitting a machine learning operation to the at least one data processing unit within a stage of the graphics processing pipeline.

In some embodiments, the data processing system may further comprise at least one storage element associated with the at least one execution unit, the method may further comprise, when a portion of the inference data received from the at least one data processing unit is not used for processing the data, the at least one execution unit storing the portion of the inference data in the storage element.

In some embodiments, the method may further comprise, when submitting a plurality of machine learning operations to the at least one data processing unit, the at least one execution unit preferentially scheduling together machine learning operations that invoke a same machine learning model.

A further aspect of the present technology provides a non-transitory computer readable storage medium comprising code which, when executed on a processor, causes the processor to: execute an instruction responsive to a command to process data on an execution engine; submit a machine learning operation on the execution engine responsive to the instruction via a direct pathway to a neural engine, the direct pathway enabling the execution engine to bypass a control unit to communicate with the neural engine; execute a machine learning model on the neural engine responsive to the machine learning operation; perform the machine learning operation on the neural engine to generate inference data; and return at least a portion of the inference data to the execution engine for processing the data.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

The present technology provide support for data processing operations, in particular graphics processing operations, through integration of machine learning into data processing pipelines in a data processing system (e.g. a graphics processing system) to facilitate improved efficiency in generating data processing products (e.g. an output for display).

Computer graphics systems produce output, such as frames for display, by, in an example, processing geometric data such as so-called primitives, which are usually simple polygons such as triangles. Each primitive is normally defined by a set of vertices (e.g. three vertices in the case of triangular primitive).

Typically, the set of vertices to be used for a given graphics processing output (e.g. frame for display) are stored as a set of vertex data defining the vertices (e.g. the relevant attributes for each of the vertices).

In the case of a typical graphics processing pipeline, the initially provided data for an output to be generated comprises a set of vertices to be used and processed for generating the output, and a set (sequence) of indices referencing the set of vertices (to, in effect, define how the vertices are used to form a set of primitives to be processed when generating the output).

Each vertex has associated with it a set of data (such as position, colour, texture coordinates and other attributes) representing the vertex. This “geometric” or “vertex” data is then used when processing a primitive that includes the vertex in order to generate the desired output of the graphics processing system.

Once the vertices and sets of vertex indices for an output have been generated, they can be processed by an execution engine to generate the desired graphics processing output (render target), such as a frame for display.

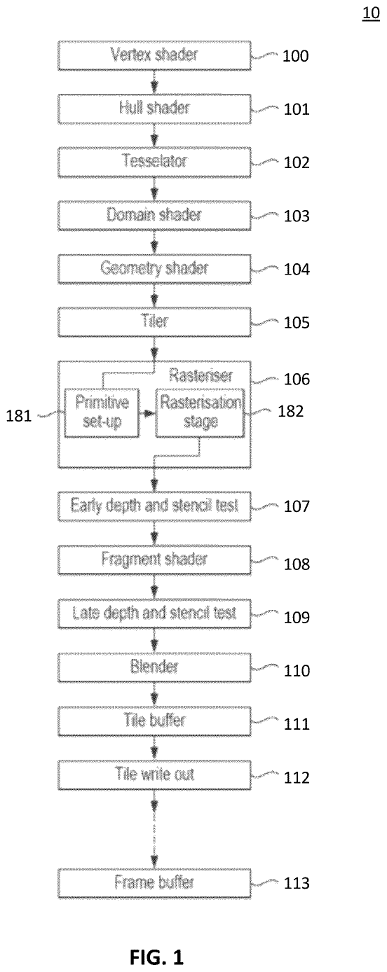

FIG. 1 shows the main elements and pipeline stages of an exemplary graphics processing pipeline 10. The present example relates to a tile-based GPU for illustrative purposes only; the present technology is relevant to other GPUs and data processors alike. As will be appreciated by those skilled in the art, there may be other elements of the graphics processing pipeline 10 that are not shown in FIG. 1, and some of the stages shown may be omitted. It should be noted here that FIG. 1 is only schematic, and that, for example, in practice, the shown functional units and pipeline stages may share significant hardware circuits, even though they are shown functionally as separate states in FIG. 1. It will also be appreciated that each of the stages, elements and units, etc., of the graphics processing pipeline 10 may be implemented as desired and may accordingly comprise, e.g., appropriate circuitry and/or processing logic, etc., for performing the necessary operation and functions.

The graphics processing pipeline 10 includes a number of stages, including a vertex shader 100, a hull shader 101 (e.g. in DirectX, or a Tessellation Control Shader in Vulkan or OpenGL), a tesselator 102, a domain shader 103 (e.g. in DirectX, or a Tessellation Evaluation Shader in Vulkan or OpenGL), a geometry shader 104, a tiler 105, a rasterization stage 106, an early Z (depth) and stencil test stage 107, a renderer in the form of a fragment shading state 108, a late Z (depth) and stencil test stage 109, a blending stage 110, a tile buffer 111, and a tile write out stage 112 that performs downsampling and writeout (multisample resolve).

The vertex shader 100 takes the input data values (vertex attribute values) associated with the vertices, etc., defined for the output to be generated, and processes those data values to generate a set of corresponding “vertex shaded” output data values for use by subsequent stages of the graphics processing pipeline 10.

The hull shader 101 performs operations on sets of patch control points and generates additional data known as patch constants. The tessellation stage 102 subdivides geometry to create higher order representations of the hull, and the domain shader 103 performs operations on vertices output by the tessellation stage (similar to a vertex shader). The geometry shader 104 may (if run) generate primitives such as triangles, points or lines for processing.

Once all the primitives to be rendered have been appropriately processed, e.g. transformed, and/or, e.g. generated by the geometry shader, the tiler 105 then determines which primitives need to be processed for each tile into which the render output has been divided for processing purposes.

Once the tiler 105 has completed the preparation of the primitive tile lists (lists of primitives to be processed for each tile), each tile is then rendered. To do so, when a given tile is being processed, each primitive that is to be processed for that tile (that is listed in a tile list for that tile) is passed to the rasteriser 106.

The rasterization stage 106 of the graphics processing pipeline 10 operates to rasterise the primitives into individual graphics fragments for processing. In particular, a primitive set-up stage 181 (otherwise known as a triangle set-up unit, TSU) of the rasteriser 106, operates to determine edge information representing each primitive edge of a primitive to be rasterised. This edge information is then passed to a rasterization stage 182 of the rasteriser 106, which rasterises the primitive to sampling points (e.g. pixels) and generates graphics fragments having appropriate positions (representing appropriate sampling positions) for rendering the primitive.

Although FIG. 1 shows the primitive set-up stage 181 being part of a single rasterization unit 106, it is possible for the primitive set-up stage to be separate from the rasteriser 106, e.g. at a stage of the graphics processing pipeline that is (e.g. immediately) before the rasteriser 106, but after the tiler 105. While in the present example rasterization is implemented, in other examples, hybrid ray tracing or ray tracing may be used for rendering a scene.

The fragments generated by the rasteriser 106 are then sent onwards to the early depth and stencil stage 107 to perform a Z (depth) test on the received fragments, to determine if any fragments can be discarded (culled) at this stage. In particular, the early depth and stencil stage 107 compares the depth values of (associated with) fragments issuing from the rasteriser 106 with the depth values of fragments that have already been rendered—these depth values are stored in a depth (Z) buffer that is part of the tile buffer 111—to determine whether the new fragments are occluded by fragments that have already been rendered (or not). At the same time, an early stencil test is also carried out.

Fragments that pass the early depth and stencil test stage 107 are then sent to the fragment shader 108. The fragment shader 108 performs the appropriate fragment processing operations on the fragments to generate the appropriate rendered fragment data. This fragment processing may include any suitable and desired fragment shading processes, such as executing fragment shader programs on the fragments, applying textures to the fragments, applying fogging or other operations to the fragments, etc., to generate the appropriate fragment data.

There is then a late depth and stencil test state 109, which carries out, amongst other things, an end of pipeline depth test on the shaded fragments to determine whether a rendered fragment can actually be seen in the final image. This depth test uses the Z-buffer value for the fragment's position stored in the Z buffer in the tile buffer 111 to determine whether the fragment data for the new fragments should replace the fragment data of the fragments that have already been rendered, by comparing the depth values of (associated with) fragments issuing from the fragment shading stage 108 with the depth values of fragments that have already been rendered (as stored in the depth buffer). This late fragment depth and stencil test stage 109 also performs any necessary late alpha and/or stencil tests on the fragments.

The fragments that pass the late fragment test stage 109 are then subjected to, if required, any necessary blending operations with fragments already stored in the tile buffer 111 in the blender 110. Any other remaining operations necessary on the fragments, such as dither, etc. (not shown) are also performed at this stage.

Finally, the (blended) output fragment data (values) are written to the tile buffer 111. The tile buffer stores colour and depth buffers that store an appropriate colour, etc., or Z value, respectively, for each sampling point that the buffers represent (in essence for each sampling point of a tile that is being processed). These buffers store an array of fragment data that represents part (a tile) of the overall render output (e.g. image to be displayed), with respective sets of sample values in the buffers corresponding to respective pixels of the overall render output (e.g. each 2×2 set of sample values may correspond to an output pixel, where 4× multisampling is being used). The tile buffer 111 may e.g. be provided as part of RAM that is located on (local to) the graphics processing pipeline (chip).

The data from the tile buffer 111 is input to a tile write out unit 112, and then output (written back) to an external memory output buffer, such as a frame buffer 113 of a display device (not shown). The display device may, for example, be a display comprising an array of pixels, such as a computer monitor or a printer.

The tile write out unit 112 downsamples the fragment data stored in the tile buffer 111 to the appropriate resolution (such that an array of pixel data corresponding to the pixels of the output device is generated) to generate output values (pixels) for output to the frame buffer 113.

Once a tile of the render output has been processed and its data exported to a main memory (e.g. to a frame buffer 113 in a main memory) for storage, the next tile is then processed, and so on, until sufficient tiles have been processed to generate the entire render output (e.g. frame to be displayed).

The process is then repeated for the next render output (e.g. frame) and so on. It should be noted that multiple tiles may be processed concurrently, for example each execution unit (e.g. shader core) may process a separately tile in parallel.

In another example, packets of data may be provided to the shader core, where each packet of data may have “n” primitives (e.g. 256 primitives). Each packet may then be processed by the shader core to determine the visible packets using their corresponding bounding boxes. It should be noted that some bounding boxes may have more than one packets. Then each shader core may check every packet to determine if they have primitives inside a current area under consideration, for example, a tile.

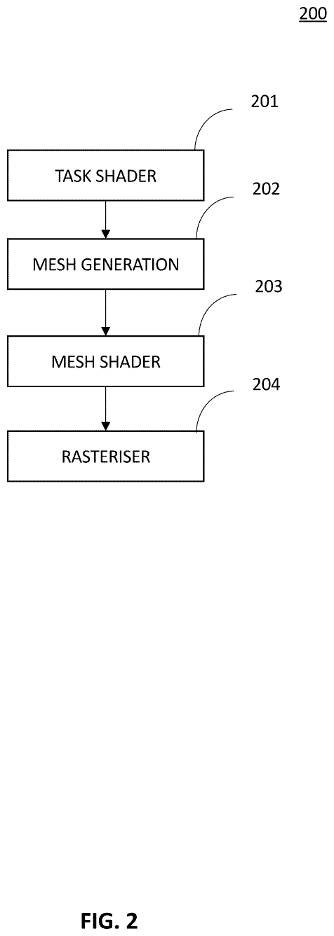

In an alternative example, rather than performing vertex processing (shading) in the manner described above, as shown in FIG. 2, a graphics processing pipeline 200 may be configured to implement “task” and “mesh” shading stages to generate primitives. The task mesh pipeline 200 receives a set of mesh tasks organized into workgroups. Each mesh task workgroups triggers a task shader invocation. Invoked by a mesh task workgroup, the task shader 201 preprocesses the geometric data in the mesh task workgroup and determine an appropriate level of detail e.g. based on visibility, then at the mesh generation stage 202 generates a set of mesh workgroups. Each mesh workgroup triggers a mesh shader invocation. Invoked by a mesh workgroup, the mesh shader 203 outputs primitives, vertices, and associated data. In contrast to the example set out with reference to FIG. 1, where a vertex shader loads in a certain number of vertices and then processes (i.e. shades) the loaded vertices, a mesh shading stage generates its own output vertices and primitives. Then, as before, each primitive to be processed is passed to the rasterizer 204. Other arrangements for a graphics processing pipeline are or course possible. The graphics processing pipeline 10 or 200 may be executed on and implemented by an appropriate graphics processing unit (GPU) that includes the necessary functional units, processing circuitry, etc., operable to execute the graphics processing pipeline stages.

In order to control a graphics processor (GPU) that is implementing a graphics processing pipeline to perform the desired graphics processing pipeline operations, the graphics processor typically receives commands and data from a driver, e.g. executing on a host processor (e.g. CPU), that indicates to the graphics processor the operations that it is to carry out and the data to be used for the operations.

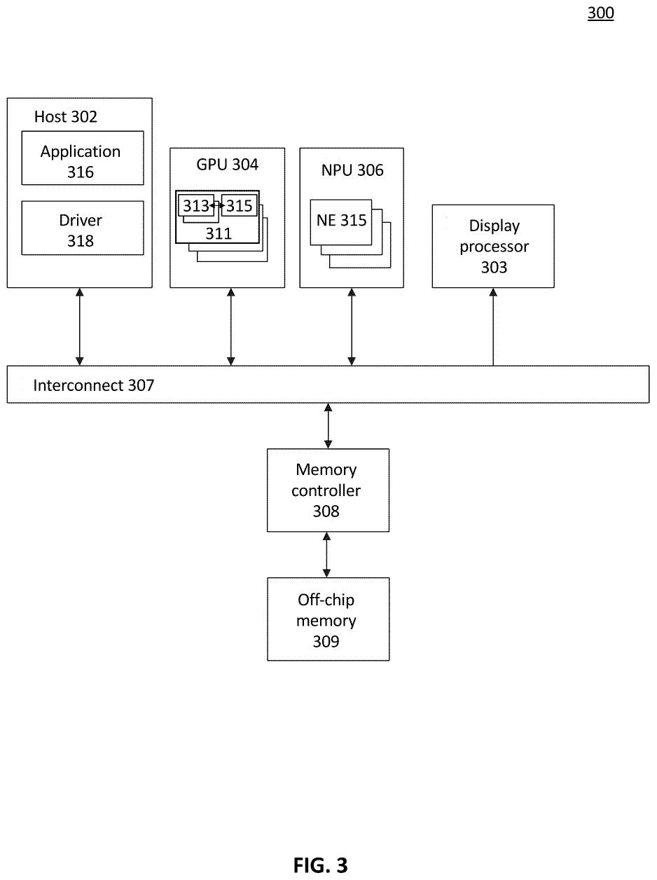

FIG. 3 shows an exemplary data processor system 300 within which the technology described herein can be implemented. The data processor system 300 in the present embodiment comprises a host processor, which may be a central processing unit (CPU) 302, a display processor 303, a graphics processor (GPU) 304, a data processor unit capable of performing machine learning and inferencing (ML) operations and is depicted herein as a neural processing unit, NPU 306, and a memory controller 308. The various units communicate via an interconnect 307 and have access to off-chip memory 309.

In the system 300, the graphics processor 304 may, for example, render frames (images) to be displayed, and the display processor 303 may then provide the frames for output, e.g. to a display panel (not shown) for display.

The NPU 306 comprises circuits (hardware) (e.g. such as multiply-accumulate circuits) configured to perform ML processing operations. In embodiments the NPU 306 may run an ML model (e.g. a neural network (NN)) to perform an ML operation, as will be described in greater detail below.

The data processor system 300 may of course include any other components or processor units that may be desired. For instance, the data processor system 300 may further comprise an image signal processor (ISP), a video decoder, an audio codec, etc., or any other components that a data processor system 300 may desirably have. Likewise, the data processor system 300 need not contain all of the components or processor units illustrated in FIG. 3.

GPU 304 executes a graphics processor pipeline that includes one or more processing stages (“shaders”), as described above with reference to FIG. 1 and FIG. 2. These shaders are processing stages that execute shader programs on input data to generate a desired set of output data in accordance with one or more tasks.

In order to execute shader programs, GPU 304 includes one or more processor cores 311 (or “shader cores” or “cores”). A processor core on the GPU 304 may comprise programmable processing circuit(s) for executing the graphics programs (e.g. shader programs). GPU 304 may comprise a single shader core 311 or a plurality of shader cores 311, as desired.

The actual data processing operations that are performed by the shader core 311 when executing a shader program may be performed by one or more execution unit(s) 313 (hereafter “execution engine” (EE) or “graphics execution engine”) having one or more functional units (circuits), such as arithmetic units (circuits), in response to, and under the control of, the instructions in the (shader) program being executed. Thus, for example, appropriate graphics functional units will perform data processing operations in response to, and as required by, commands/instructions in a (shader) program being executed. (e.g. received from the host processor 302).

Each shader core 311 may comprise further components and units necessary for the execution of (shader) programs, such as, for example, local storage (e.g. one or more register files and/or L0 cache) for storing data for use by the execution engine 313 when executing a (shader) program, tile buffer, Texture Mapper (for performing texture mapping operations), RTU (Ray Tracing Unit) for perform ray tracing operations, or Neural Engine (NE) to perform ML processing tasks, etc. It will be appreciated the shader core may have additional or alternative components or units.

NPU 306 typically comprises one or more data processing unit(s) 315 to perform processing operations of a particular type or types. In the present illustrative example, the data processing unit 315 comprises one or more functional unit(s) to perform ML operations, such as to execute one or more ML models. Such ML models may comprise, for example, convolutional neural networks (CNN) or graph neural networks (GNN). The NPU 306 may also comprise storage (not shown) to store data related to the ML operations.

In some embodiments, the NPU 306 may be a discrete processor unit separate from the GPU 304. In other embodiments, the functionality of the NPU 306 may be integrated into the GPU 304, where, for example, the GPU 304 may comprise neural network processing capabilities. In an illustrative example depicted in FIG. 3, each shader core 311 of the GPU 304 may have its own dedicated data processing unit (neural engine) 315 to provide neural network processing capabilities. It should be noted that an integrated data processing unit 315 may be provided as an alternative to the separate NPU 306, or it may be provided to the GPU 304 in addition to the NPU 306.

In the present embodiments NPU 306 is provided to support the GPU 304 during graphics processing operations. For example, the machine learning hardware accelerator (hereafter “neural engine”) may be used to perform ML operations as will be described in greater detail below.

As an illustrative example, application 316 executes on host processor 302 and requires graphics processing operations to be performed by the GPU 304, at which point a software driver 318 on the host processor 302 generates a command stream(s) to cause the GPU 304 to operate in response to the command stream(s). For example, the application 316 (e.g. a game or a simulation) may submit commands and data to the driver 318 for the GPU 304. The driver 318 may then generate commands and data to cause the GPU 304 to render frames for display, and to store those frames in frame buffers, e.g. in the off-chip memory 309. The display processor 303 may then read (stream) the frames from off-chip memory 309 via an internal buffer and may then output the data to a display panel of the display (not shown).

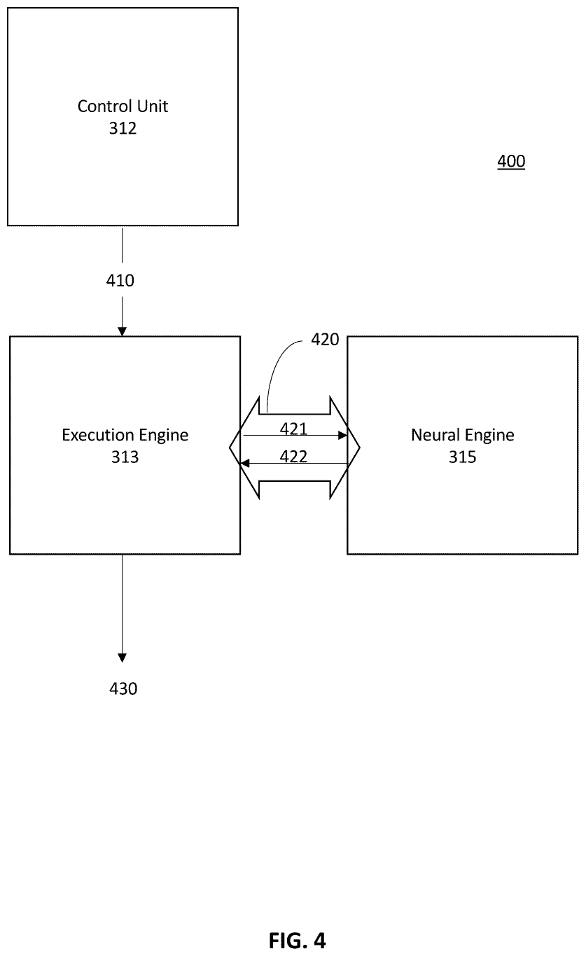

Embodiments of the present technology enable integration of machine learning into a data processing pipeline to e.g. support graphics operations. The ML operations may be performed at a GPU (e.g. at a compute shader or at a neural engine integrated therein). Additionally or alternatively, the ML operations may be performed at a processor unit separate from the GPU, for example at an NPU or any other processing unit capable of performing ML operations. In the embodiments, such integration of machine learning in a data processing pipeline is facilitated by providing the execution engine (e.g. 313) of the shader core (e.g. 311) and the data processing unit (e.g. neural engine 315) with the capability to directly communicate with each other, as described below. FIG. 4 illustratively depicts a data processing arrangement 400 to process data, such as graphics processing, in response to command(s) received at a data processor, such as the GPU 304 of FIG. 3. The data processing arrangement comprises at least one data processing unit, such as the data processing unit 315, at least one execution unit, such as the execution unit 313 in the shader core 311 of the GPU 304, and a control unit 312 which schedules processing workload on the execution unit 313.

The execution unit 313 is configured to execute an instruction 410 received from the control unit 312 responsive to a command to process data. Where the instruction requires the performance of one or more ML operations, for example if the instruction is an instruction to perform the one or more ML operations, or execution of the instruction requires data generated by the one or more ML operations, the execution unit 313 submits 421 the one or more ML operations to the data processing unit 315 responsive to the instruction. This may be in the form of information on the operation to be performed on the data or a pointer to a data structure containing an operation to be performed, and the data to be processed itself or a pointer to the data to be processed.

The data processing unit 315 is to perform the one or more ML operations on the data using one or more ML models, responsive to the execution unit 313, to generate inference data 422, and return the generated inference data 422 to the execution unit 313, where the inference data is used to complete the data processing operation at the shader core 111 to output data processing product 430.

In the following embodiments, the data processing unit 315 is described as a “neural engine” and is to perform ML operations in accordance with the present technology. It should be noted that the data processing unit 315 may be (and in some embodiments is) part of a GPU, and it may be a neural engine integrated within a shader core or an execution unit capable of performing ML operations.

The ML operations comprise running, executing or operating on data received from or indicated by the execution unit using one or more ML models such as a Neural Network (NN). The ML model(s) for a particular operation and one or more parameters of the ML model (e.g. weights, biases, and connectivity of the network) may be fetched from storage as required for a particular ML operation. In embodiments, when the ML model is large, a portion of the ML model may be fetched at a time, for example a layer of the ML model or a sub-portion of a layer of the ML model may be fetched in order. When storage is constrained, partial results are output from memory, (for example the output of one layer), and then fetched (read back in) for processing a next layer.

The data processing arrangement is configured such that the execution unit 313 is capable of directly communicating with the data processing unit 315. In present embodiments, a direct pathway 420 (e.g. a direct message passing interface) that bypasses the control unit 312 is provided between the execution unit 313 and the data processing unit 315 to enable the execution unit 313 to directly submit an ML operation to the data processing unit 315 without involving the control unit 312. The direct communication pathway may for example be a dedicated message passing interface. In particular, executing the instruction may cause a message to be generated at the execution unit 313, and the execution unit 313 sends the message 421 to the data processing unit 315 via the direct communication pathway 420.

Herein, a message passing interface may comprise one or more point to point connections. For example, the interface may be a single-to-many-endpoint, or many-to-many interface; in this scenario the message passing interface may use a source and destination identifiers. In some embodiments, each connection may comprise one or more signals (wires). Each message passing interface may comprise a request interface and a response interface. The message passing interface may contain just a requestor (message generator) and a subservient (message receiver). Alternatively, the message passing interface may comprise a requestor, a receiver and interconnect components, for example a message passing router component. Optionally, each message passing interface may comprise a unique interface and protocol for that connection. For single-to-many or many-to-many message passing interfaces, there may optionally be a standard protocol for each of the requestors and responders.

The message may, for example, includes an indication of the one or more ML models to execute, the input data for the one or more ML operations or an indication of the location(s) of the input data. In some cases, the input data required for the one or more ML operations may be an intermediate product of executing the instruction, then, the execution unit 313 is to partially execute the instruction so as to generate the input data for the one or more operations. Different levels of inference for generating the inference data may be desired for different ML operations; thus, the message may further include a level of inference. For example, the execution unit may determine the level of inference based on the level of detail required for processing the data (as explained further below).

The present technology thus integrates ML operations as a part of data processing operations, such as graphics processing pipelines in shader cores, through the execution engine directly invoking (and optionally generating the input for) the neural engine. Then, when the neural engine has completed the invoked ML operation(s), some or all of the inference data is output to the execution engine to complete the execution of the instruction. This enables the neural engine and ML operations to operate more locally on a smaller scale (e.g. a small portion of a frame, a patch/segment) instead of operating on a larger scale (e.g. an entire mesh) and/or during post-processing, to allow multiple patches/segments to be processed by the neural engine in parallel and/or each patch/segment to be processed independently (e.g. at a different level of detail) as required.

In an example, a shader processing (or operating on) geometry, e.g. a tessellator, in a graphics processing pipeline may incorporate ML operation(s) on a patch level. Herein, patches may be defined statically, e.g. by the ML model(s) used, or they may be defined dynamically by the shader (e.g. based on spatial locality, normal map, displacement map, etc.). In this case, the shader drives the level of detail/complexity along with other data such as normal maps or displacement maps, which can then be incorporated with the execution of the ML model(s). Such scenarios typically involve sampling from a displacement map and generating the required level of detail (LOD) based on the overall rendering pipeline, e.g. position, distance to camera, normals direction, performance and latency, etc. The required LOD is a useful indication for the level of processing required for the execution of the ML model(s). For example, a low LOD may result in less complex geometry being generated by the ML model, whereas a high LOD may generate more complex geometry.

It would be inefficient for the neural engine to execute the one or more ML models on data that corresponds to geometry that will not be visible and therefore will not be rendered. It may therefore be desirable to have the execution engine executing a shader that is processing (or operating on) the geometry (e.g. a geometry/mesh shader) driving the complexity of the ML model inference, for example, to not submit a request to the ML model for a patch that is not visible, and/or to submit a request specifying the LOD for a patch that is visible. As the complexity of the geometry at least partially depends on the distance to the camera and other factors that dictate its LOD, it may be assumed, at least in some cases, that the level of inference corresponds to the same level.

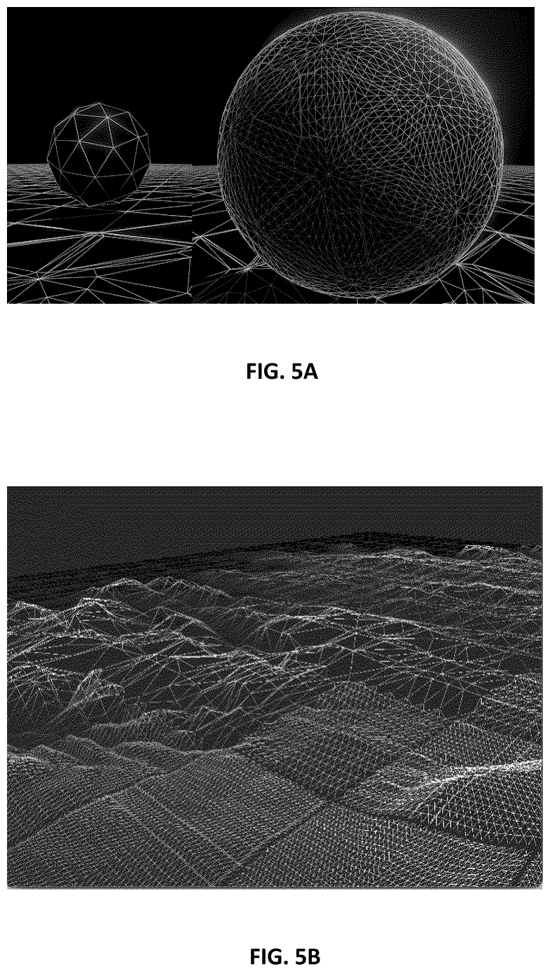

As can be seen in the images shown in FIG. 5A and FIG. 5B, geometry that is closer to the current viewpoint is denser as the render output is more visible and impactful, and it is expected that the denser geometry at the front closer to the camera, or geometry with surface normal aligning with the camera, would require higher LOD, and therefore more ML processing and/or more data to be input into the ML model(s).

In some embodiments, the execution engine may invoke the neural engine to independently execute both an ML model on a coarser level e.g. to ensure that the overall appearance of a frame is correct and to avoid discrepancies amongst different regions of the frame, and another ML model on a finer grain level (e.g. per patch). It should be noted that in different implementations, the coarser level ML model may be optional as there are other suitable ways of ensuring consistency, or the finer level ML model may be optional (e.g. depending on performance/computational budget and/or latency, or whether additional information such as the relative importance of objects is available). The coarser level ML model and the finer level ML model may be the same or they may be different models (e.g. same or different NNs).

Executing a neural engine within an execution engine as part of a shader program introduces performance optimizations. This may be facilitated by a new instruction causes the execution engine to generate and send a message to the neural engine. The message may carry a pointer to a descriptor indicating the ML model (e.g. neural network) to execute. In order to minimize toggling of ML models inside the neural engine, it may be desirable to keep track of the ML model(s) a shader program executes, and preferentially schedule ML work to neural engine hardware that has the ML model(s) loaded, or when the ML model(s) is already loaded into the neural engine.

The present technology challenges the current assumption that ML and data (e.g. graphics) processing are independent stages of the overall application pipeline. To facilitate an execution model in which neural engines have tighter integration with execution engines, a message passing interface with the execution engine(s) (such as Texture Mapper TEX or Ray Tracing Unit RTU) may, in some embodiments, be implemented where, for example, each warp may submit NEDs (Neural Engine Descriptors) and each thread is executed in batch dimension in parallel. Weights may be shared between warps, which can be stored e.g. in a software controlled workgroup memory, while output may e.g. be stored in an LSC (loaded store cache). Different scenarios are anticipated: all shaders are executing the same ML model; multiple ML models are executed, optionally different one (or more) for each shader; the architecture of an ML model may be the same but the weights may be different. Other scenarios are of course possible.

In the embodiments, polygon meshes are processed in small portions and depending on the tessellator/mesh shader, varying level of detail may be fed as input for inference. Thus, the shader program (e.g. tessellation or geometry or mesh shader) operates on a patch/cluster and determines the level of detail, submits an inference job to an associated neural engine for that segment, and incorporates the inference result in the shader processing. In a task mesh pipeline, a task shader may invoke one or more mesh shaders. The task shader can determine an appropriate number of mesh shaders to execute, and at the same time, the task shader can determine one or more portions of geometry data or vertex data (mesh) that are interesting and therefore which portion(s) to focus on. Typically, in the case of mesh shaders, each work group is able to generate a limited number of new primitives, and the input mesh is split into portions or meshlets (clusters of geometry) where each work group operates on a portion of the mesh. The generation of meshlets is generally performed as part of the asset preparation and not during runtime.

In a task mesh graphics pipeline, task shaders are used to preprocess geometry, determine an appropriate LOD, determine the number of mesh shaders to dispatch based e.g. on visibility. Thus, it may be desirable to submit inference workload from task shaders. During processing, simple geometry may sometimes be modified by texture or displacement maps and further geometry may be generated. The modification(s) and/or generation of further geometry may result in the simple geometry that was not previously visible becoming visible. Therefore, in some embodiments, it may be desirable to account for such variabilities on visibility e.g. by using a threshold on a displacement map, network and/or LOD basis, to allow for previously non-visible geometry becoming visible through further processing.

Once the neural engine has completed an ML operation invoked by the execution engine and the execution engine has completed the execution of the instruction using the inference data output by the neural engine, the computed result may be stored e.g. in Geometry Packet Pipelines GPPs. In some embodiments, the ML operation may generate a plurality of primitives. In some embodiments, the ML operation may generate a plurality of packets. In some embodiments, the ML operation may place the generated primitives in a packet, for example, each packet may comprise one or more primitives. Preferably, these packets are evenly distributed. Optionally, any information that is not currently required, e.g. information/data corresponding to (a part of) geometry that is not visible in the current frame, may be stored or updated in a displacement map, and the stored information may then be used in subsequent frames (for both inference as well as other rendering effects, lighting, shadows, reflections, etc.) without inputting this information into the remaining parts of the graphics pipeline and rendering. In doing so, it is possible to ensure the information is not lost or wasted, especially in cases where there are dependencies between consecutive frames, while at the same time additional overhead for processing data that is not visible in the current frame is minimized.

The present technology is not limited to tessellator and mesh shader, other examples exist where it is appropriate or preferable to approach mesh processing in small portions. In some cases, generative AI can be used to generate terrain and other objects in the terrain such as vegetation, lakes, building, etc. that is part of a scene. For example, a multimodal large language model LLM, may be prompted to generate a scene that a user may refine, and the mesh portion processing may be implemented in such refining processes, for instance, to make changes in a part of some parts of the scene such as to modify the level of detail or to modify one or more elements of the part(s). In such cases, instead of rebuilding the whole scene mesh each time a change is made to a part some parts, small portions of the scene may be modified independently. The present technology may therefore be particularly relevant to the use of generative AI to generate whole scenes from text prompt.

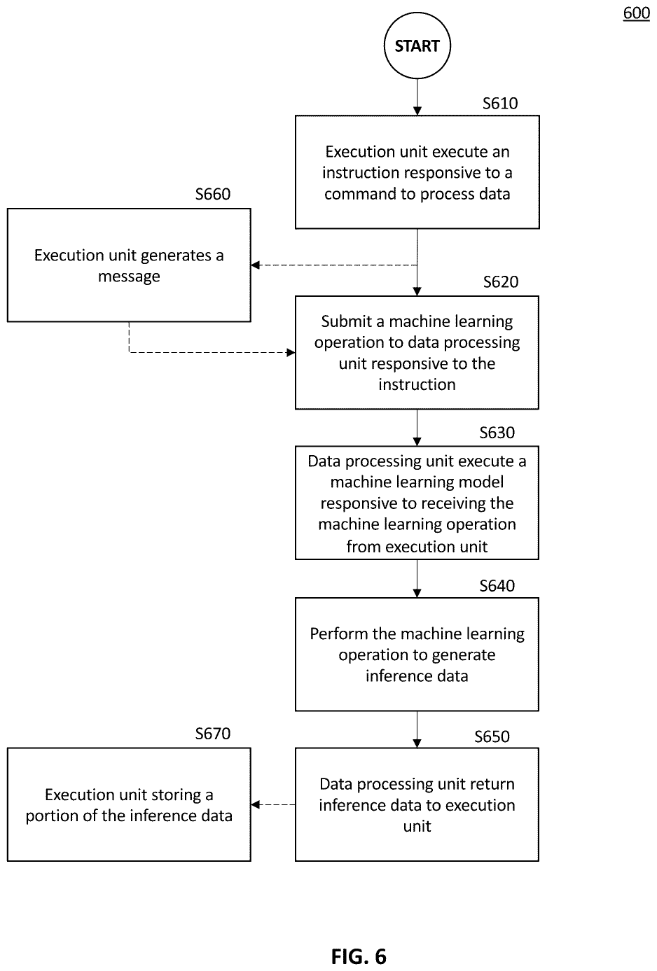

FIG. 6 shows a method of operating a data processing system, such as the data processing arrangement 400 in FIG. 4, which comprises at least one data processing unit (e.g. data processing unit 315), at least one execution unit (e.g. execution unit 313) and a control unit (e.g. control unit 312), the at least one execution unit being capable of communicating with the data processing unit via a direct pathway that bypasses the control unit. The method begins at S610 when the at least one execution unit executes an instruction responsive to a command to process data, such as an instruction received by a shader core to perform graphics processing. Responsive to the instruction, the execution unit submits a machine learning operation to the data processing unit via the direct pathway at S620.

Responsive to receiving the machine learning operation from the at least one execution unit, the at least one data processing unit executes a machine learning model at S630, and performs the machine learning operation to generate inference data at S640. The data processing unit then returns the inference data to the at least one execution unit at S650.

In some embodiments, a dedicated message passing interface between the execution unit and the data processing unit may be implemented. Thus, at S660, the at least one execution unit generates a message upon executing the instruction and sends the message to the at least one data processing unit via the message passing interface.

There may be scenarios where a portion of the inference data generated by the data processing unit is not currently required, for example if the portion of inference data corresponds to geometry that is not visible in the current frame. Thus, at S670, for a portion of the inference data that is not used for processing the data, the at least one execution unit stores the portion of the inference data in a storage element associated with the at least one execution unit.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high-speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

The examples and conditional language recited herein are intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its scope as defined by the appended claims.

Furthermore, as an aid to understanding, the above description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to limit the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

It will be clear to one skilled in the art that many improvements and modifications can be made to the foregoing exemplary embodiments without departing from the scope of the present techniques.

What is claimed is:

1. A data processing system comprising:
at least one data processing unit;
at least one execution unit; and
a control unit to schedule processing workload on the execution unit,
wherein the at least one execution unit is capable of communicating with the at least one data processing unit via a direct pathway that bypasses the control unit,
the at least one execution unit being configured to:
execute an instruction responsive to a command to process data; and
submit a machine learning operation to the at least one data processing unit responsive to the instruction via the direct pathway,
the at least one data processing unit being configured to:
execute a machine learning model responsive to receiving the machine learning operation from the at least one execution unit;
perform the machine learning operation to generate inference data; and
return at least a portion of the inference data to the at least one execution unit.

2. The data processing system of claim 1, wherein the at least one data processing unit is configured to return the at least a portion of the inference data to the at least one execution unit via the direct pathway.

3. The data processing system of claim 1, wherein the data processing system is a graphics processor and the data to be processed is graphics data, the at least one execution unit is configured to execute the instruction in a graphics processing pipeline, and to submit a machine learning operation to the at least one data processing unit within a stage of the graphics processing pipeline.

4. The data processing system of claim 1, wherein the direct pathway comprises a message passing interface.

5. The data processing system of claim 4, wherein the at least one execution unit is configured to generate a message and send the message to the at least one data processing unit via the message passing interface.

6. The data processing system of claim 5, wherein the message comprises one or more of: an indication of the machine learning model to execute, input data for the machine learning operation, an indication of a location of input data for the machine learning operation, a level of processing for generating the inference data.

7. The data processing system of claim 6, wherein the at least one execution unit is configured to generate the input data for the machine learning operation.

8. The data processing system of claim 6, wherein the at least one execution unit is configured to determine the machine learning model to execute based on a level of detail for processing the data.

9. The data processing system of claim 8, wherein the data to be processed is graphics data corresponding to a portion of geometry in a scene, and the at least one execution unit is configured to determine the level of detail based on a position of the portion of geometry in the scene, a distance to a virtual camera position, visibility of the portion of geometry with respect to the viewpoint, a direction of one or more normals of the portion of geometry, current performance of the data processing system, current latency of the data processing system, or any combination thereof.

10. The data processing system of claim 8, wherein the data to be processed is graphics data, the at least one execution unit being configured to execute the instruction in a task mesh pipeline comprising at least a task shader and a mesh shader, and the task shader is configured to determine the level of detail for processing the portion of geometry and submit the machine learning operation to the data processing unit with an indication of the machine learning model to execute for generating the inference data based on the level of detail.

11. The data processing system of claim 1, wherein the at least one execution unit is configured to submit a first machine learning operation to the at least one data processing unit to be performed on a portion of the data to be processes at a first level of processing, and to submit a second machine learning operation to the at least one data processing unit to be executed on a plurality of portions of the data to be processed at a second level of processing lower than the first level.

12. The data processing system of claim 1, further comprising at least one storage element associated with the at least one execution unit, wherein the at least one execution unit is configured to, when a portion of the inference data received from the at least one data processing unit is not used for processing the data, store the portion of the inference data in the storage element.

13. The data processing system of claim 1, wherein the at least one execution unit is configured to, when submitting a plurality of machine learning operations to the at least one data processing unit, preferentially schedule together machine learning operations that invoke a same machine learning model.

14. The data processing system of claim 1, wherein the at least one data processing unit is a neural engine and the at least one execution unit and is implemented as a separate unit from the at least one data processing unit, or the at least one data processing unit is integrated into the at least one execution unit.

15. A method of operating a data processing system that comprises at least one data processing unit, at least one execution unit, and a control unit to schedule processing workload on the execution unit, the at least one execution unit being capable of communicating with the at least one data processing unit via a direct pathway that bypasses the control unit, the method comprising:
the at least one execution unit:
executing an instruction responsive to a command to process data;
submitting a machine learning operation to the at least one data processing unit responsive to the instruction via the direct pathway,
the at least one data processing unit:
executing a machine learning model responsive to receiving the machine learning operation from the at least one execution unit;
performing the machine learning operation to generate inference data; and
returning at least a portion of the inference data to the at least one execution unit.

16. The method of claim 15, wherein the direct pathway comprises a message passing interface, and the method further comprises the at least one execution unit generating a message and sending the message to the at least one data processing unit via the message passing interface.

17. The method of claim 15, wherein the data processing system is a graphics processor and the data to be processed is graphics data, and the at least one execution unit executes the instruction in a graphics processing pipeline, the method further comprising the at least one execution unit submitting a machine learning operation to the at least one data processing unit within a stage of the graphics processing pipeline.

18. The method of claim 15, wherein the data processing system further comprises at least one storage element associated with the at least one execution unit, the method further comprising, when a portion of the inference data received from the at least one data processing unit is not used for processing the data, the at least one execution unit storing the portion of the inference data in the storage element.

19. The method of claim 15, further comprising, when submitting a plurality of machine learning operations to the at least one data processing unit, the at least one execution unit preferentially scheduling together machine learning operations that invoke a same machine learning model.

20. A non-transitory computer readable storage medium comprising code which, when executed on a processor, causes the processor to:
execute an instruction responsive to a command to process data on an execution engine;
submit a machine learning operation on the execution engine responsive to the instruction via a direct pathway to a neural engine, the direct pathway enabling the execution engine to bypass a control unit to communicate with the neural engine;
execute a machine learning model on the neural engine responsive to the machine learning operation;
perform the machine learning operation on the neural engine to generate inference data; and
return at least a portion of the inference data to the execution engine for processing the data.
